(19) United States
(12) Patent Application Publication
(10) Pub. No.: US 2006/0108136 A1
(43) Pub. Date: May 25, 2006

(54) Rotary air joint for pneumatic tool

(76) Inventor: Kuo-Jung Leu, Taichung County (TW)

Correspondence Address: BACON & THOMAS, PLLC, 625 SLATERS LANE, FOURTH FLOOR, ALEXANDRIA, VA, 22314, US

(21) Appl. No.: 11/268,492

(22) Filed: Nov. 8, 2005

(30) Foreign Application Priority Data
Nov. 23, 2004 (TW) 93218817

(51) Int. Cl. B25D 11/00

(52) U.S. Cl. 173/201

(57) ABSTRACT

A rotary air joint includes a tool connector fastened to an air inlet of a pneumatic tool, a plug member coupled to and rotatable relative to the tool connector, a first rotary member connected between the plug member and a high-pressure air tube and rotatable with the plug member and the high-pressure air tube relative to the tool connector, and a flow regulating member mounted in the first rotary member and coupled to the plug member for regulating the flow rate of compressed air outputted from the high-pressure air tube to the pneumatic tool and allowing rotation of the first rotary member with the plug member relative to the pneumatic tool.

### BACKGROUND OF THE INVENTION

1. Field of the Invention

The present invention relates to pneumatic tools and more specifically, to a rotary air joint for pneumatic tool.

2. Description of the Related Art

A regular pneumatic tool has a swivel type air inlet for connection to a high-pressure air tube of a high-pressure air source. After connection of the air inlet of the pneumatic tool to the high-pressure air tube, the pneumatic tool can only be rotated in one direction relative to the high-pressure air tube. During working, the high-pressure air tube may hinder movement of the pneumatic tool by the operator. Further, an air flow regulating device may be installed in the connection line between the pneumatic tool and the high-pressure air tube for regulating the flow rate of the compressed air to the pneumatic tool. This attached air flow regulating device is complicated, and requires much installation space.

### SUMMARY OF THE INVENTION

The present invention has been accomplished under the circumstances in view. It is therefore the main object of the present invention to provide a rotary air joint, which allows turning in different directions and regulation of the flow rate of compressed air passing therethrough. It is another object of the present invention to provide a rotary air joint, which has a simple structure and is durable in use.

To achieve these and other objects of the present invention, the rotary air joint is coupled between an air inlet of a pneumatic tool and a high-pressure air tube, comprising: a tool connecting assembly coupled to the air inlet of the pneumatic tool, the tool connecting assembly comprising a plug member; a first rotary member, the first rotary member having a body, a coupling hole coupled to the plug member, a first receiving hole formed in the body of the first rotary member at one side and disposed in communication with the coupling hole of the first rotary member, and a second receiving hole formed in the body of the first rotary member at an opposite side; and a flow regulating member mounted in the first receiving hole of the body of the first rotary member and coupled to the plug member for allowing rotation of the first rotary member with the plug member relative to the pneumatic tool.

### BRIEF ESCRIPTION OF THE DRAWINGS

FIG. 1 is a schematic drawing showing the arrangement of a rotary air joint between a high-pressure air tube and a pneumatic tool according to the present invention.

FIG. 2 is a sectional assembly view of the rotary air joint according to the present invention.

FIG. 3 is a sectional exploded view of the rotary air joint according to the present invention.

FIG. 4 is a schematic side view of the plug member for the rotary air joint according to the present invention.

FIG. 5 is a schematic top view of the plug member for the rotary air joint according to the present invention.

FIG. 6 is a schematic side view of the first rotary member for the rotary air joint according to the present invention.

FIG. 7 is a schematic side view of the flow regulating member for the rotary air joint according to the present invention.

FIG. 8 is a schematic drawing showing one adjustment example of the rotary air joint after connection between the pneumatic tool and the high-pressure air tube according to the present invention.

FIG. 9 is an exploded view of a part of a rotary air joint according to a second embodiment of the present invention.

FIG. 10 is an exploded view of a part of a rotary air joint according to a third embodiment of the present invention.

FIG. 11 is a sectional assembly view of a rotary air joint according to a fourth embodiment of the present invention.

FIG. 12 is a sectional exploded view of a rotary air joint according to a fifth embodiment of the present invention.

FIG. 13 is a sectional assembly view of a rotary air joint according to a fifth embodiment of the present invention.

FIG. 14 is a sectional assembly view of a rotary air joint according to a sixth embodiment of the present invention.

### DETAILED DESCRIPTION OF THE INVENTION

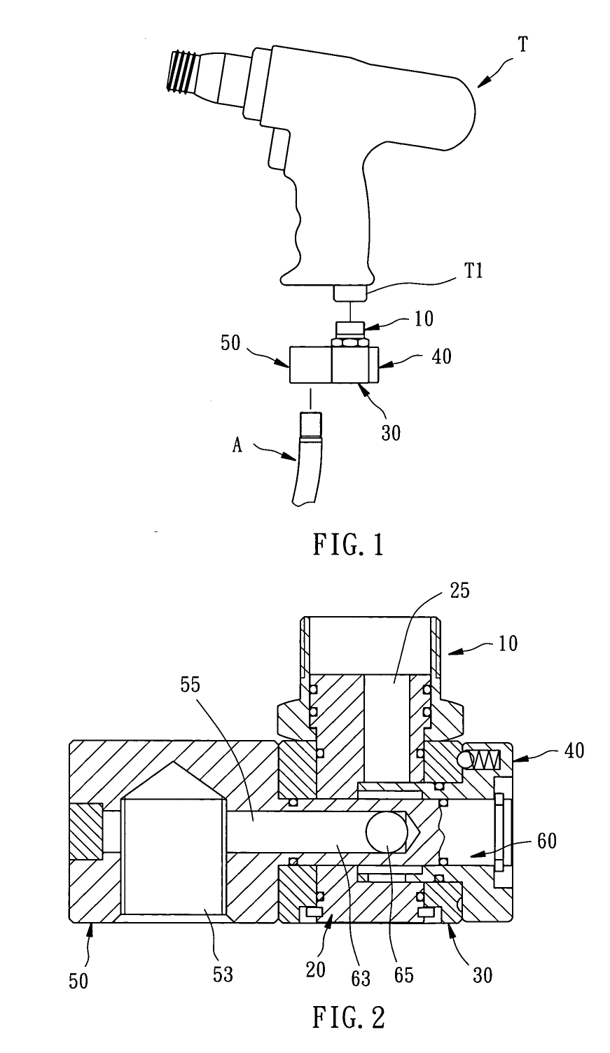

Referring to FIG. 1, a rotary air joint in accordance with the present invention is adapted to couple the air inlet T1 of a pneumatic tool T to a high-pressure air tube A.

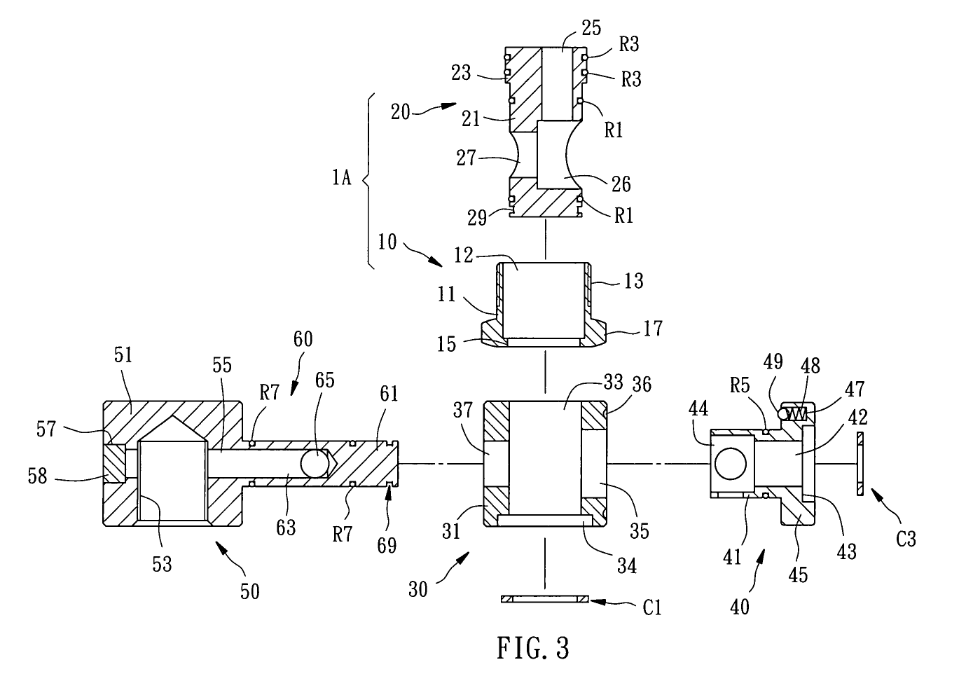

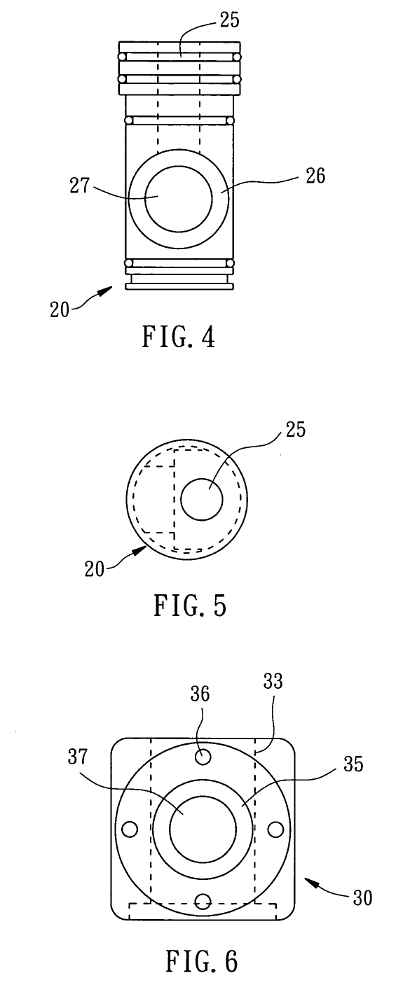

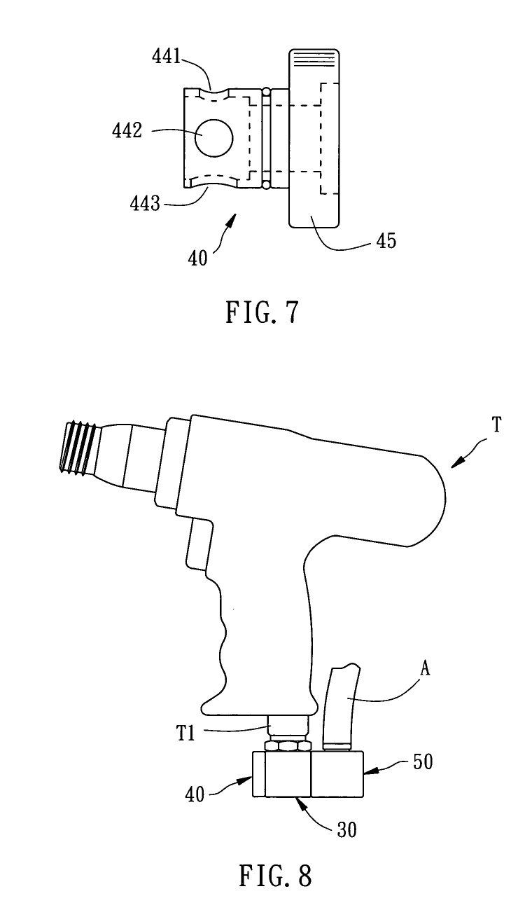

Referring to FIGS. 2-7 and FIG. 1 again, the rotary air joint comprises:

A tool connector 10, which has a connector body 11, a through hole 12 through two distal ends of the connector body 11, an outer thread 13 extending around the periphery of the connector body 11, an inside coupling flange 15 at one end of the through hole 12, and an outside locating flange 17 corresponding to the inside coupling flange 15.

A plug member 20, which has a plug body 21, two first seal rings R1 fastened to the periphery of the plug body 21 at different elevations, a coupling portion 23 formed integral with one end of the plug body 21, two second seal rings R3 fastened to the periphery of the coupling portion 23 at different elevations, an air passage 25 axially extending through the coupling portion 23 for guiding compressed air from the high-pressure air tube A into the air inlet T1 of the pneumatic tool T, a first receiving hole 26 formed in the plug body 21 at one side, a second receiving hole 27 formed in the plug body 21 at the opposite side in communication with the first receiving hole 26, and a locating groove 29 extending around the periphery of the plug body 21 near one end remote from the coupling portion 23.

The aforesaid tool connector 10 and plug member 20 form a tool connecting assembly 1A.

A first rotary member 30, which has a body 31, a coupling hole 33, which extends through the two distal ends of the body 31 and receives the plug member 20 for enabling the first rotary member 30 to be rotated relative to the tool connector, a locating groove 34 disposed at one end, a first receiving hole 35 formed in the body 31 at one side and disposed in communication with the first receiving hole 26 of the plug member 20, a second receiving hole 37 formed in the body 31 at the opposite side and disposed in communication with the second receiving hole 27 of the plug member 20, and a plurality of recessed locating portions 36 formed in the periphery of the body 31, a first retaining ring C1 fastened to the locating groove 29 of the plug member 20 and positioned in the locating groove 34 of the first rotary member 30 to secure the plug member 20 to the first rotary member 30, for allowing rotation of the first rotary member 30 relative to the tool connector 10.

A flow regulating member 40, which has a barrel 41 inserted into the first receiving hole 35 of the first rotary member 30 and the first receiving hole 26 of the plug member 20, a seal ring R5 fastened to the periphery of the barrel 41 to seal the gap between the barrel 41 and the first rotary member 30, an axial coupling hole 42 axially extending through the two distal ends of the barrel 41, a locating groove 43 formed in one end of the barrel 41 around the axial coupling hole 42, an air passage 44 formed of multiple air holes 441, 442 and 443, a handle 45, a spring holder 47 disposed at one end of the outside wall of the barrel 41, a spring 48 mounted in the spring holder 47, and a steel ball 49 supported on the spring 48 outside the spring holder 47 for selectively positioned in one of the recessed locating portions 36 of the first rotary member 30 to hold one of the air holes 441, 442 and 443 in air communication between the axial coupling hole 42 and the air passage 25 of the plug member 20.

A second rotary member 50, which has a body 51, a first coupling hole 53, which is a screw hole threaded onto one end of the high-pressure air tube A, a second coupling hole 55 extending across the first coupling hole 53, a plug hole 57 in communication with one end of the second coupling hole 55, and a stopper 58 mounted in the plug hole 57.

A connecting member 60, which has a shaft body 61 fixedly perpendicularly extending from the periphery of the body 51 of the second rotary member 50 and inserted through the second receiving hole 37 of the first rotary member 30 and the coupling hole 42 of the flow regulating member 40 for allowing rotation of the second rotary member 50 relative to the first rotary member 30, two seal rings R7 fastened to the periphery of the shaft body 61 to seal the gap between the shaft body 61 and the first rotary member 60 and the gap between the shaft body 61 and the flow regulating member 40, a longitudinal air hole 63 axially formed in the shaft body 61 in air communication with the high-pressure air tube A via the second coupling hole 55 and first coupling hole 53 of the second rotary member 50, a transverse air hole 65 transversely formed in the shaft body 61 and perpendicularly extending from one end of the longitudinal air hole 63 for guiding compressed air from the high-pressure air tube A into the air passage 44 of the flow regulating member 40; and a locating groove 69 extending around the periphery of the shaft body 61 near one end remote from the second rotary member 50; and a second retaining ring C3 fastened to the locating groove 69 of the coupling member 60 and positioned in the locating groove 43 of the flow regulating member 40.

When the rotary air joint is assembled and coupled between the air inlet T1 of the pneumatic tool T to the high-pressure air tube A, the first rotary member 30 can be rotated in X-axis direction relative to the tool connector 10, and the second rotary member 50 can be rotated in Y-axis direction relative to the first rotary member 30, therefore the high-pressure air tube A can be turned to any desired angle relative to the pneumatic tool T (see FIG. 8).

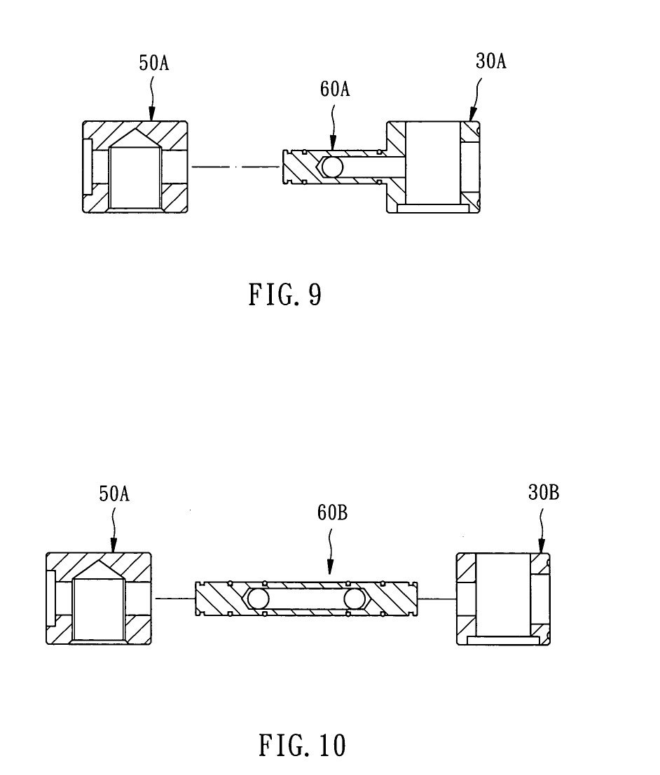

FIG. 9 is an exploded view of a part of a rotary air joint according to a second embodiment of the present invention. According to this embodiment, the connecting member 60A is fixedly connected to the first rotary member 30A, and the second rotary member 50A is detachably and rotatably coupled to the connecting member 60A.

FIG. 10 shows an exploded view of a part of a rotary air joint according to a third embodiment of the present invention. According to this embodiment, the first rotary member 30B is detachably fastened to one end of the connecting member 60B, and the second rotary member 50A is detachably and rotatably coupled to the other end of the connecting member 60B.

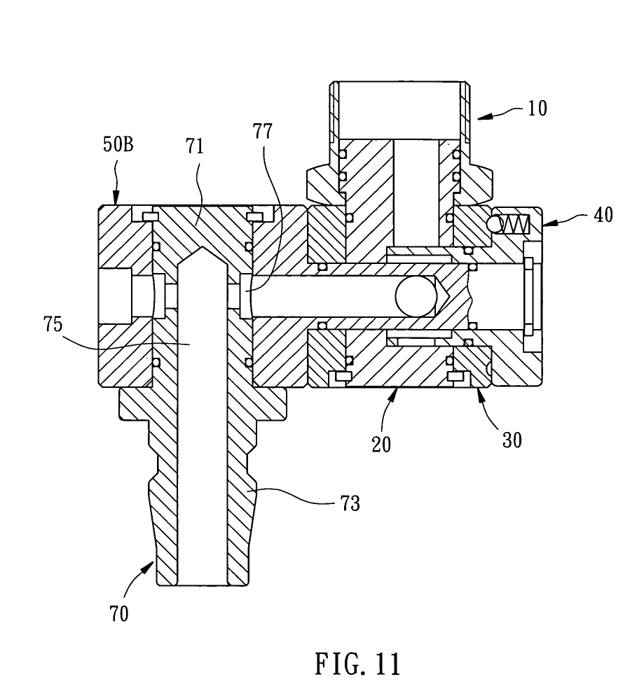

FIG. 11 is a sectional assembly view of a rotary air joint according to a fourth embodiment of the present invention. According to this embodiment, a third rotary member 70 is rotatably coupled to the second rotary member 50B and adapted to couple the second rotary member 50B to the high-pressure air tube. The third rotary member 70 has a body 71 coupled to the second rotary member 50B, a mounting portion 73 formed integral with one end of the body 71 for fastening to the high-pressure air tube, and an air passage 75 axially extending through the mounting portion 73 into the inside of the body 71 and adapted to guide compressed air from the high-pressure air tube to the flow regulating member 40 through the second rotary member 50B.

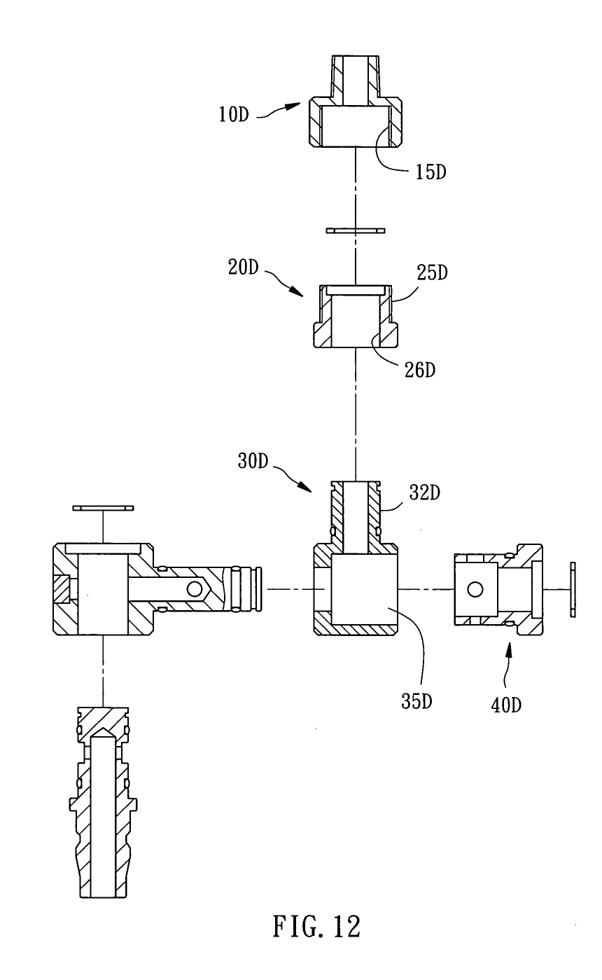

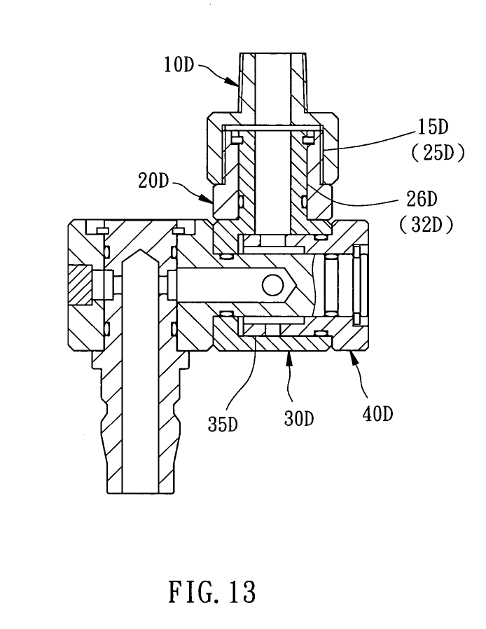

FIGS. 12 and 13 is sectional exploded and assembly view of a rotary air joint according to a fifth embodiment of the present invention. According to this embodiment, the tool connector 10D has a thread 15D; the plug member 20D has a thread 25D thread connected to the thread 15D of the tool connector 10D, a pivot portion 26D of a through hole; the first rotary member 30D has a pivot portion 32D of a pivot barrel rotatable inserted into the pivot portion 26D of the plug member 20D, a first receiving hole 35D; and the flow regulating member 40D is rotatable inserted inside the first receiving hole 35D of the first rotary member 30D. Therefore, the connect structure between the plug member 20D and first rotary member 30D is more simplified, and also between the first rotary member 30D and the flow regulating member 40D.

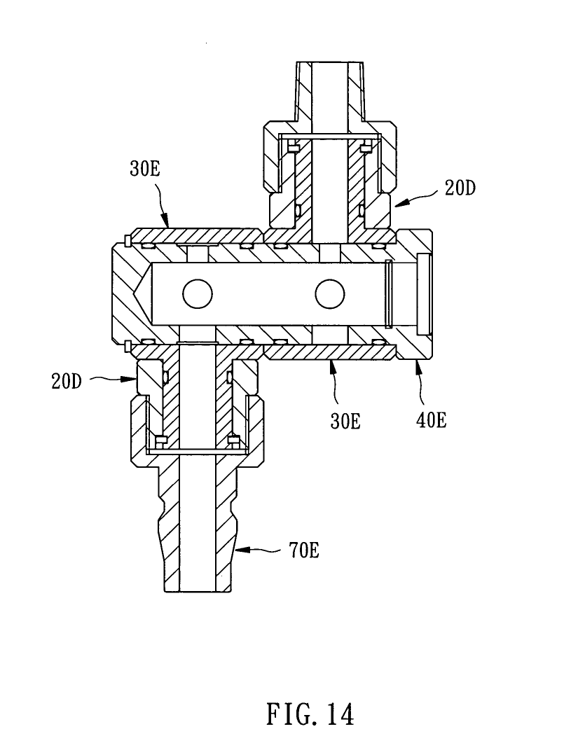

FIG. 14 is a sectional assembly view of a rotary air joint according to a sixth embodiment of the present invention. According to this embodiment, the rotary air joint comprises two first rotary member 30E and one is instead of the second rotary member, the flow regulating member 40E is rotatable connected the both first rotary member 30E; two plug member 20D rotatable and sealing connected to the both first rotary member 30E; therefore, the second rotary member can be the same part of the first rotary member 30E for common use and simplified the structure of the present invention. The third rotary member 70E is connected with one of the plug member 20D and rotatable relative to one of the first rotary member 30E.

As indicated above, the invention provides a rotary air joint for pneumatic tool, which has the following characteristics:

1. The rotary air joint allows turning of the high-pressure air tube relative to the pneumatic tool in any direction and regulation of the flow rate of compressed air from the high-pressure air source to the pneumatic tool.

2. The a rotary air joint has a simple structure and is durable in use.

What is claimed is:

1. A rotary air joint coupled between an air inlet of a pneumatic tool and a high-pressure air tube, comprising:
a tool connecting assembly rotatable coupled to said air inlet of said pneumatic tool, said tool connecting assembly having a plug member, said plug member having a first receiving hole;
a first rotary member having a body, a coupling hole coupled to said plug member, a first receiving hole formed in said body of said first rotary member at one side and disposed in communication with said coupling hole of said first rotary member, and a second receiving hole formed in said body of said first rotary member at an opposite side; and
a flow regulating member mounted in said first receiving hole of said first rotary member and coupled to said first receiving hole of said plug member for allowing rotation of said first rotary member with said plug member relative to said pneumatic tool.

2. The rotary air joint as claimed in claim 1, wherein said tool connecting assembly further comprises a tool connector fastened to said air inlet of said pneumatic tool and rotatable coupled to said plug member.

3. The rotary air joint as claimed in claim 1, further comprising a second rotary member, said second rotary member having a body adapted to connect said high-pressure air tube to said first rotary member for allowing turning of said second rotary member relative to said first rotary member.

4. The rotary air joint as claimed in claim 3, further comprising a connecting member coupled between said first rotary member and said second rotary member for guiding a compressed air from said high-pressure air tube to said first rotary member.

5. The rotary air joint as claimed in claim 4, wherein said connecting member coupled to said flow regulating member.

6. A rotary air joint coupled between an air inlet of a pneumatic tool and a high-pressure air tube, comprising:
a first rotary member having a body coupled to and rotatable relative to said air inlet of said pneumatic tool, said body of said first rotary member having a first receiving hole;
a second rotary member, said second rotary member having a body coupled between said first rotary member and said high-pressure air tube for allowing rotation of said first rotary member relative to said high-pressure air tube, said body of said second rotary member having a first coupling hole coupled to said first rotary member and a second coupling hole connected to said high-pressure air tube; and
a connecting member coupled between said first coupling hole of said body of said second rotary member and said first receiving hole of said first rotary member, said connecting member having a first air hole disposed in air communication with said first receiving hole of said first rotary member and a second air hole disposed in air communication with said first air hole and said high-pressure air tube.

7. The rotary air joint as claimed in claim 6, wherein said connecting member has one end formed integral with one of said first rotary member and said second rotary member.

8. The rotary air joint as claimed in claim 6, further comprising a flow regulating member mounted in one of said first rotary member and said second rotary member for regulating the flow rate of the compressed air.

9. The rotary air joint as claimed in claim 6, further comprising a tool connecting assembly coupled between said first rotary member and said air inlet of said pneumatic tool for enabling rotary of said first rotary member relative to said pneumatic tool.

10. The rotary air joint as claimed in claim 6, further comprising a third rotary member coupled between said second rotary member and said high-pressure air tube and rotatable relative to said second rotary member.

11. A rotary air joint coupled between an air inlet of a pneumatic tool and a high-pressure air tube, comprising:
a tool connecting assembly coupled to said air inlet of said pneumatic tool, said tool connecting assembly having a plug member, said plug member having a pivot portion and a coupling hole;
a first rotary member having a body, a pivot portion coupled to said pivot portion of said plug member, a first receiving hole formed in said body of said first rotary member at one side and disposed in communication with said coupling hole of said first rotary member, and a second receiving hole formed in said body of said first rotary member at an opposite side; and
a flow regulating member mounted in said first receiving hole of said first rotary member, an air passage in communication with said second receiving hole of said first rotary member, and a air hole in communication with said air passage.

12. The rotary air joint as claimed in claim 11, wherein said tool connecting assembly further comprises a tool connector fastened to said air inlet of said pneumatic tool and coupled to said plug member.

13. The rotary air joint as claimed in claim 11, wherein said tool connecting assembly further comprises a connecting member coupled with said first rotary member.

14. The rotary air joint as claimed in claim 13, wherein said connecting member is rotatable pivoted to said first receiving hole of said first rotary member.

15. The rotary air joint as claimed in claim 13, wherein said connecting member further pivot with said flow regulating member.

16. The rotary air joint as claimed in claim 13, wherein said connecting member is formed integral with said flow regulating member.

17. The rotary air joint as claimed in claim 13, further comprising a second rotary member connected to said connecting member for free rotation with said first rotary member.

18. The rotary air joint as claimed in claim 17, wherein said connecting member is formed integral with said second rotary member.

19. The rotary air joint as claimed in claim 17, further comprising a third rotary member coupled between said second rotary member and said high-pressure air tube and rotatable relative to said second rotary member.

20. The rotary air joint as claimed in claim 19, further comprising a plug member having a pivot portion, said third rotary member is rotatable connected to said pivot portion of said plug member.
